(19) United States
(12) Patent Application Publication
(10) Pub. No.: US 2018/0266174 A1
(43) Pub. Date: Sep. 20, 2018

(54) DOOR FOR PERSONNEL INGRESS AND EGRESS PROVIDED WITHIN A LARGER DOOR FOR VEHICLES

(71) Applicant: Eazadyar Mataghedi, Myrtle Beach, SC (US)

(72) Inventor: Eazadyar Mataghedi, Myrtle Beach, SC (US)

(21) Appl. No.: 15/927,051

(22) Filed: Mar. 20, 2018

Related U.S. Application Data
(60) Provisional application No. 62/473,579, filed on Mar. 20, 2017.

(51) Int. Cl. E06B 7/32; E06B 3/48

(52) U.S. Cl. CPC E06B 7/32; E06B 2003/7044; E05Y 2900/132; E06B 3/485

(57) ABSTRACT

A smaller door for the ingress and egress of persons through a garage door opening is provided within the larger garage door. The smaller door allows the ingress and egress of persons through a garage door opening without the need to open the larger garage door, which is sized to allow the passage of relatively larger vehicles.

### BACKGROUND OF THE INVENTION

The typical suburban home is equipped with one or more garage doors of the type known as overhead garage doors or, more simply, overhead doors. These overhead doors lift up out of the way to allow ingress and egress of vehicles, such as automobiles, sports utility vehicles (SUVs), vans, and the like, into and out of the garage. The lifting of these overhead doors is usually accomplished by an electrically powered opening and closing apparatus. A significant amount of energy is required for closing and opening the overhead doors. Also, the opening and closing process of the overhead door is relatively slow and imposes the inconvenience of waiting for the process to complete on the person opening or closing the overhead door. It often happens that persons need to exit or enter through the garage door, but they have to incur the energy and time penalty of opening and closing the overhead door each time they wish to do so. Also, in the winter time in the colder regions, opening the large garage door quickly turns the air inside the garage frigid, which makes working inside the garage difficult and unpleasant and further causes energy to be wasted in reheating the inside space of the garage. It would be desirable to provide a convenient means of entering or exiting a home through the garage door without having to incur the energy and time penalty of operating the opening and closing apparatus of the overhead door.

### SUMMARY OF THE INVENTION

The present invention provides a smaller door for the ingress and egress of persons through a garage door opening without the need to open the larger garage door that is sized to allow the passage of relatively large vehicles as described above. The smaller door is provided within the larger garage door and forms part of the larger garage door. The width of the smaller door is preferably in the range typical of house and/or room entry doors. A practical example of the width for the smaller door would be about three feet. The height of the smaller door is limited by the height of the garage door, but is preferably less than the full height of the garage door. A practical example of the height for the smaller door would be about six and one half feet. The smaller door may be openable from the inside only, or provision may be made for the smaller door to be lockable and openable from both the inside of the garage and from the outside.

Accordingly, it is an aspect of the present invention to provide a main door adapted for selectively allowing passage of vehicles into a building structure, the main door being formed in part by a secondary door dimensioned and configured for allowing ingress and egress of persons through the secondary door without the need for opening the main door in its entirety, wherein the secondary door is smaller than the main door.

It is another aspect of the present invention to provide a secondary door for providing a selectively openable closure for an opening dimensioned for the passage of persons in a main door that is dimensioned to provide a selectively openable closure for a passageway dimensioned for the passage of vehicles suitable for conveying at least one person into or out of a building structure, the secondary door comprising:

at least one secondary door panel; and

at least one hinge for attaching the secondary door panel to the main door, the secondary door panel being pivotally movable relative to the main door about a first hinge axis defined by the at least one hinge,

wherein the passageway has an area and the opening has an area and wherein the area of the passage way is larger than the area of the opening.

It is yet another aspect of the present invention to provide a secondary door incorporating any of the above-described aspects of the present invention, wherein the main door is an overhead door, wherein the main door has a width, a height, and a plurality of segments including a first segment and a last segment, each segment extending horizontally for the width of the main door, the first segment being adjacent the bottom of the passageway when the main door is in the closed position, the last segment having an upper edge that defines the top edge of the main door when the main door is in the closed position, wherein, starting from the first segment to the last segment, each segment is pivotally hinged to the adjacent succeeding segment such that each segment and its adjacent succeeding segment are capable of pivotal movement relative to each other about a horizontal hinge axis, wherein two or more of the segments have an open portion that cooperatively define the opening in the main door for passage of persons, wherein the secondary door has two or more panels that are each pivotally hinged to any adjacent such panels such that each panel and any of its adjacent panels are capable of pivotal movement relative to each other about a horizontal hinge axis, wherein the at least one hinge is one of a plurality of hinges connecting the secondary door to the main door, wherein the plurality of hinges connecting the secondary door to the main door permit the secondary door to move pivotally relative to the main door about a vertical axis when the main door is in the closed position, each pair of adjacent panels of the secondary door are pivotally movable relative to each other about a horizontal axis that is coincident with a horizontal axis about which a corresponding pair of main door segments are pivotally connected.

It is yet another aspect of the present invention to provide a secondary door incorporating any of the above-described aspects of the present invention, further comprising a latch for holding the secondary door in a closed position relative to the main door.

These and other aspects and advantages of the present invention will be further elucidated by the following Detailed Description, drawing figures, and Claims.

### BRIEF DESCRIPTION OF THE DRAWING FIGURES

FIG. 1 shows an inside view of a closed garage door having a secondary door in accordance with the present invention that is also in the closed position.

FIG. 2 shows a close-up view from the inside of the garage of a closed garage door having a secondary door in accordance with the present invention that is also in the closed position.

FIG. 3 shows a close-up view from the inside of the garage of the guide track and guide rollers of a closed garage door having a secondary door in accordance with the present invention.

FIG. 4 shows a close-up view from the inside of the garage of the latch and keeper, shown in the closed configuration, of a closed garage door having a secondary door in accordance with the present invention that is also in the closed position.

FIG. 5 shows an outside view of a closed garage door having a secondary door in accordance with the present invention that is also in the closed position.

FIG. 6 shows an outside view of a garage door having a secondary door in accordance with the present invention that is in the closed position as the garage door is being lifted toward the open position.

FIG. 7 shows an inside view of a garage door having a secondary door in accordance with the present invention that is in the closed position as the garage door is being lifted toward the open position.

FIG. 8 shows an inside view of a closed garage door having a secondary door in accordance with the present invention with the secondary door in the open position.

FIG. 9 shows a close-up view from the inside of the garage of the latch and keeper, shown in the open configuration, of a closed garage door having a secondary door in accordance with the present invention with the secondary door in the open position.

FIG. 10 shows a close-up view from the inside of the garage of the keeper of a garage door having a secondary door in accordance with the present invention with the garage door in the closed position and the secondary door in the open position.

### DETAILED DESCRIPTION

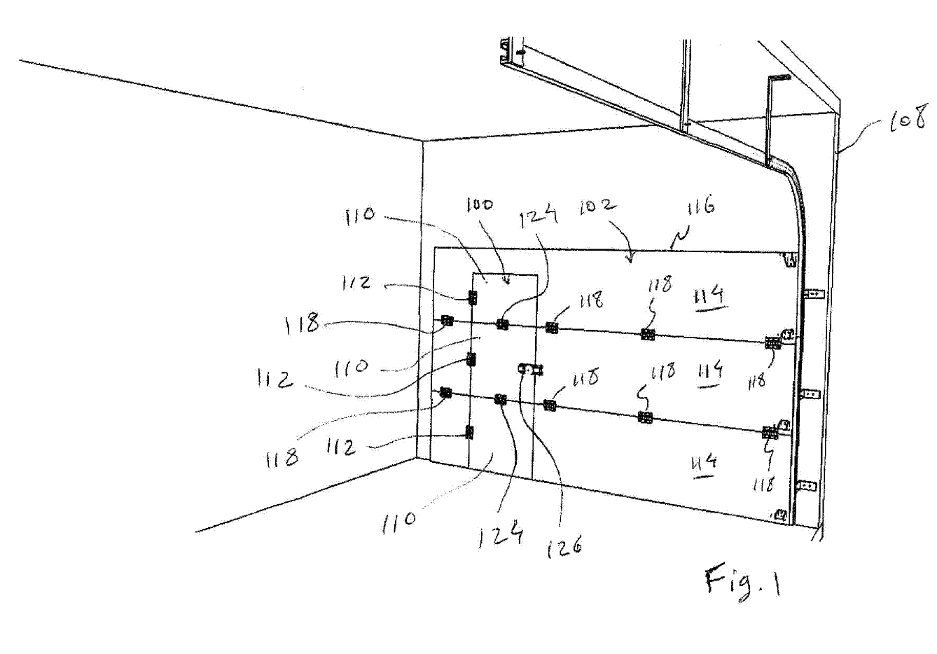

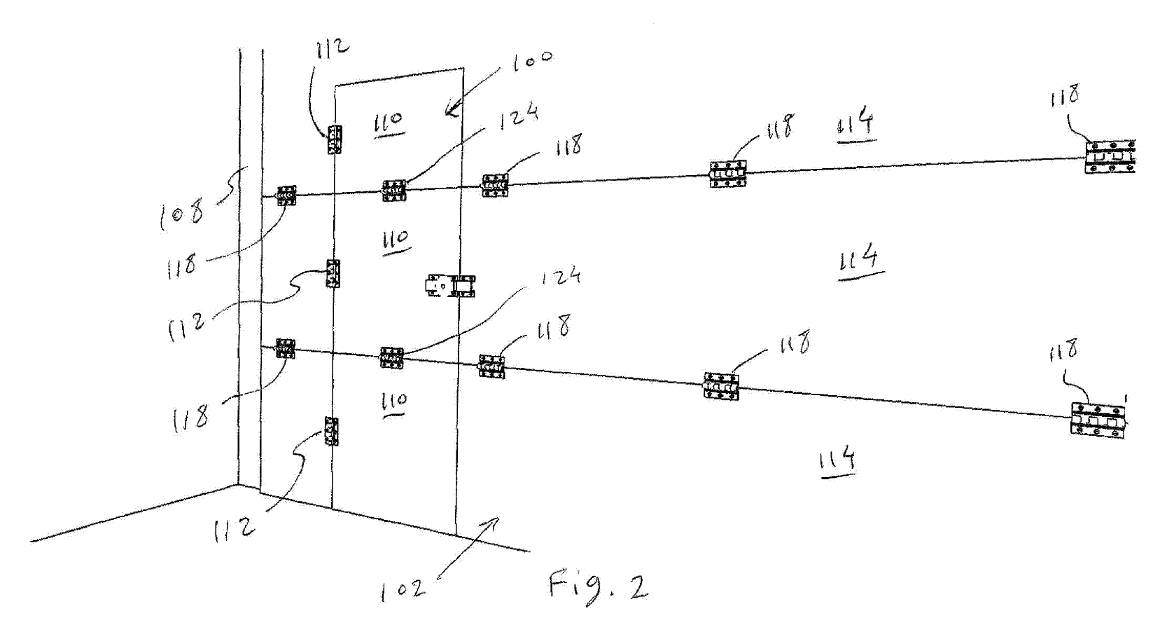

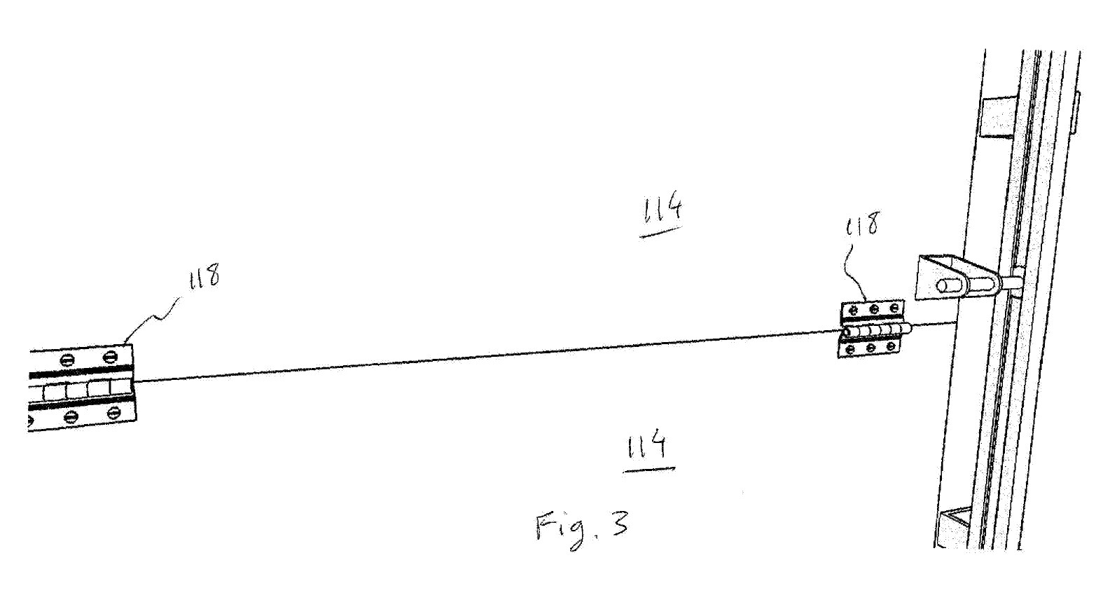

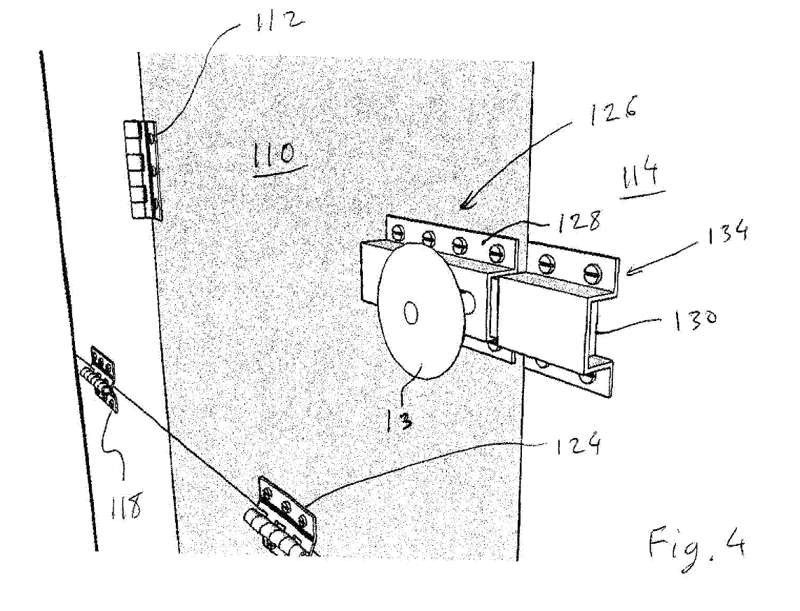

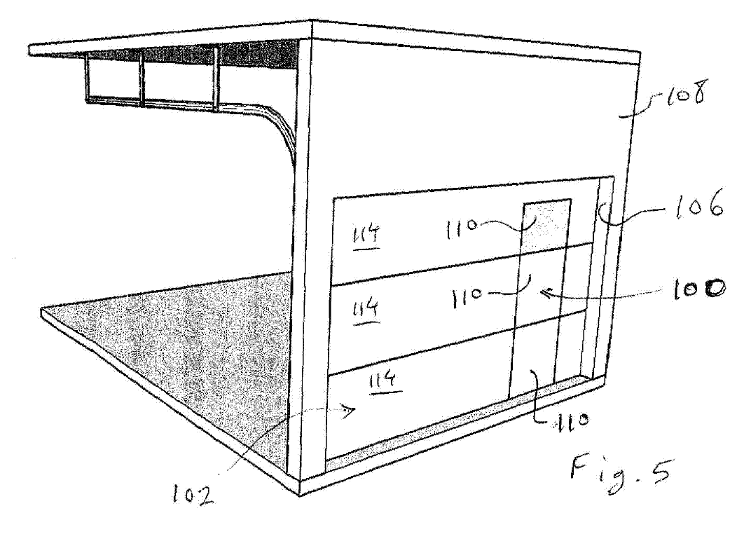

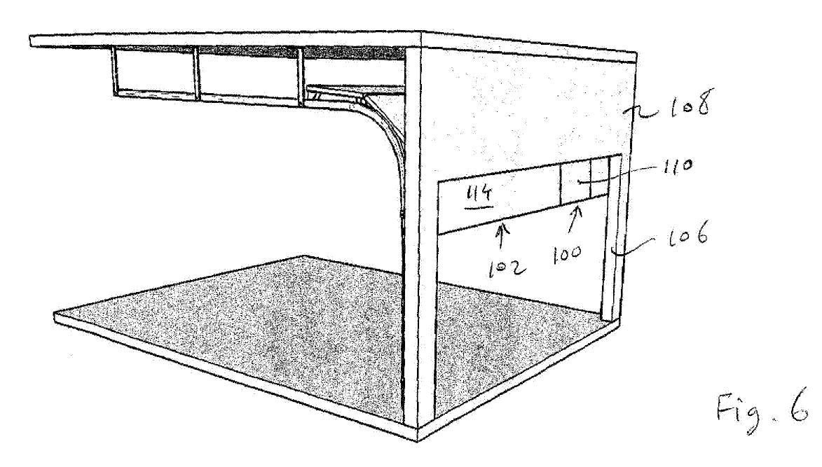

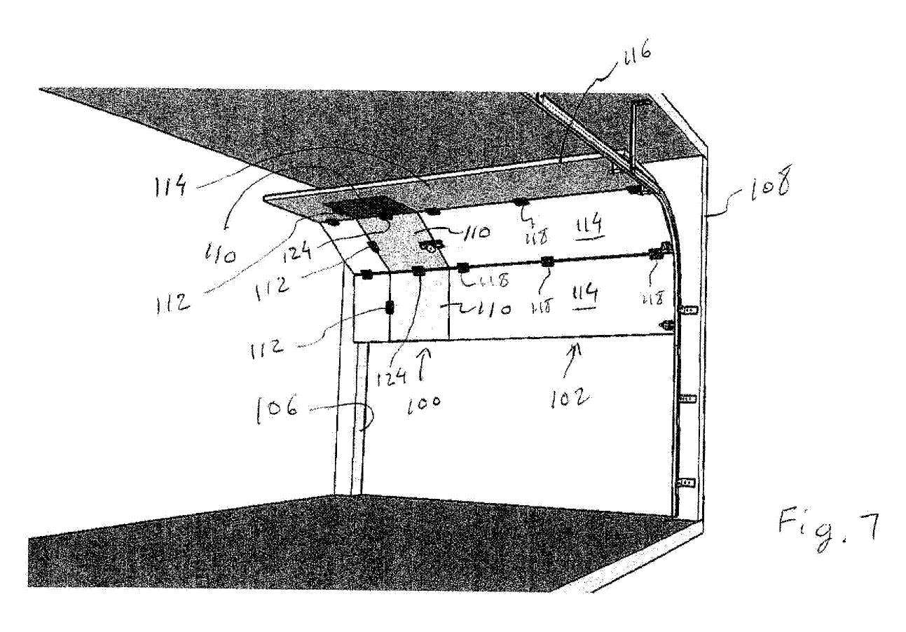

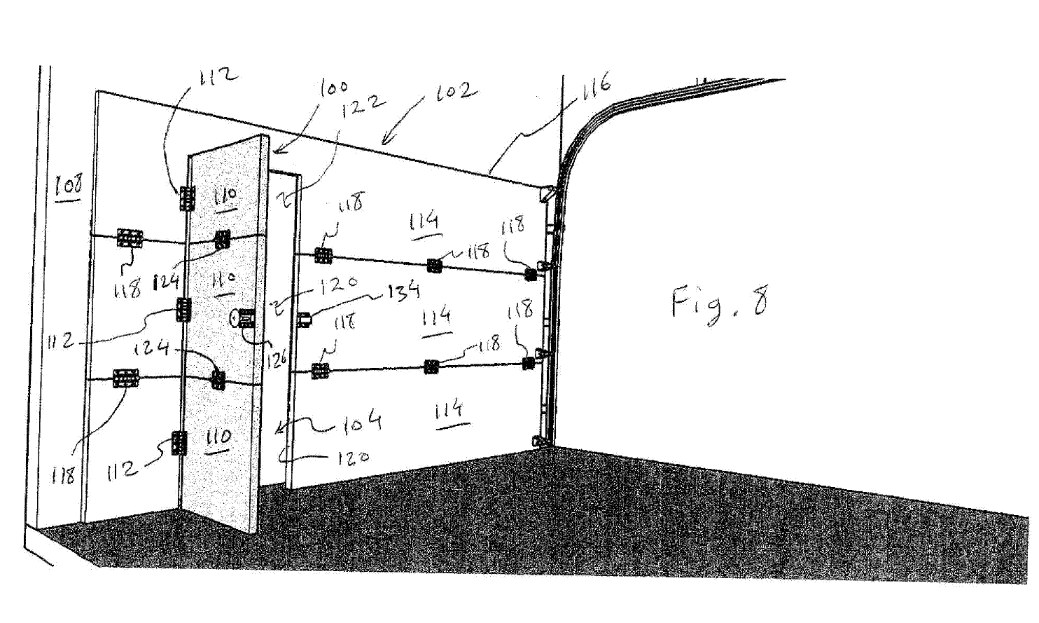

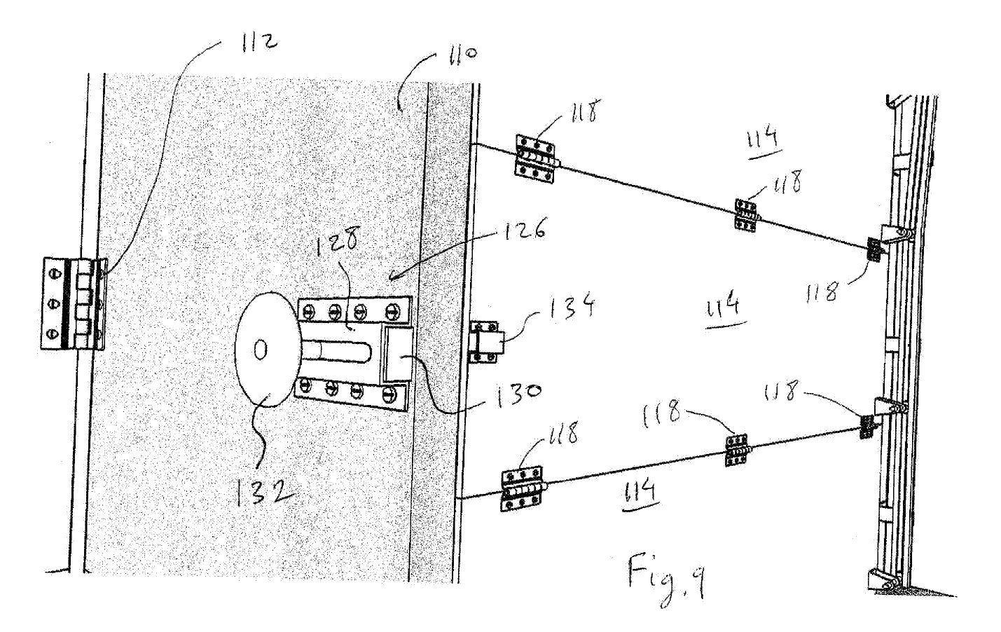

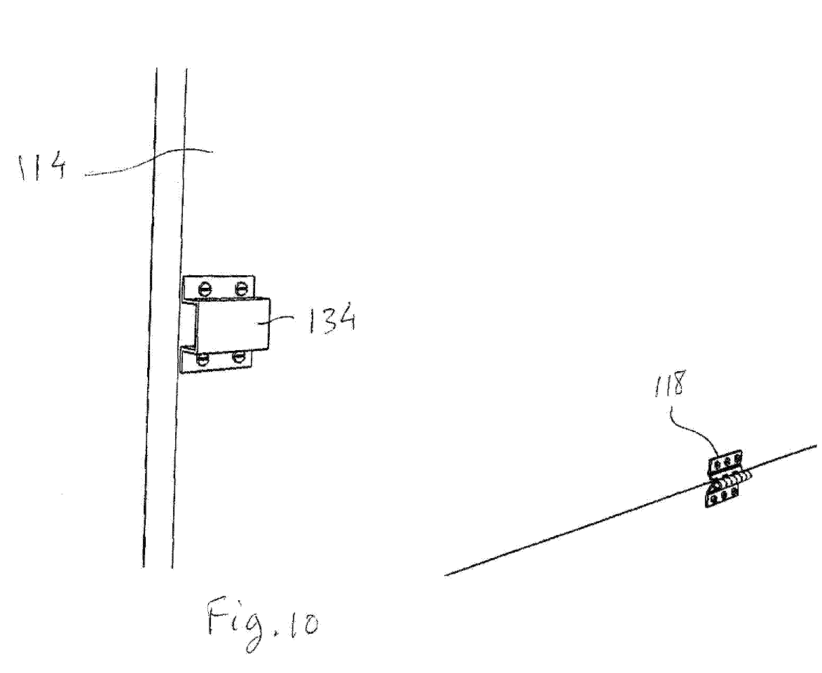

Referring to FIGS. 1-10, the present invention is directed to a secondary door 100 provided in a larger door 102. The larger door 102 can, for example and without limitation, be a residential or commercial garage door, an automotive service bay door, an aircraft hangar door, a loading dock door, a barn door, or the like. The larger or main door 102 can, for example, be an overhead door or of the horizontally sliding type. The larger or main door 102 can, for example, be made of one large door panel having an opening for the secondary door 100, or it can be made of multiple segments. If the door 102 is made of multiple segments, then at least some of segments will each have an open portion, with the open portions of the segments cooperatively forming the opening for the secondary door 100.

In the illustrated example, the main door 102 is a segmented overhead door typically used as the door for residential garages that commonly form parts of suburban houses or other building structures. In the illustrated example, the main door 102 is adapted for selectively allowing passage of vehicles into a building structure. The main door 102 is formed in part by a secondary door 100, which is dimensioned and configured for allowing ingress and egress of persons through the secondary door 100 without the need for opening the main door 102 in its entirety. The secondary door 100 is generally smaller than the main door 102.

The secondary door 100 provides a selectively openable closure for an opening 104, which is dimensioned for the passage of persons. The opening 104 is provided in a main door 102 that is dimensioned to provide a selectively openable closure for a passageway 106, which is dimensioned for the passage of vehicles suitable for conveying at least one person into or out of a building structure 108. In the illustrated embodiment, the vehicles would typically be motorcycles, automobiles, sports utility vehicles (SUVs), vans, and the like. Depending on the application, the vehicles could also be aircraft, trucks, agricultural or construction machinery and the like. More generally, the main door 102 would be dimensioned to allow the passage of items, equipment, or machinery that is too large to fit through doorways dimensioned for entry or exit of individuals or persons and typically found as entry ways to residential houses or as entry ways to rooms within residential houses.

The secondary door 100 includes at least one secondary door panel 110 and at least one hinge 112 for attaching the secondary door panel 110 to the main door 102. The secondary door panel 110 is pivotally movable relative to the main door 102 about a first hinge axis defined by the at least one hinge 112. In the illustrated example, the first hinge axis is a vertical axis when the main door 102 is in the closed position, as illustrated in FIGS. 1, 2, and 4. The frontal area of passageway 106 is larger than the frontal area of the opening 104.

In the illustrated example, the main door 102 is an overhead door. The main door 102 has a width, a height, and a plurality of segments 114 including a first segment and a last segment. Each segment 114, including any open portion as part of the segment, extends horizontally for the width of the main door 102. The first segment 114 is adjacent the bottom or floor of the passageway 106 when the main door 102 is in the closed position. The last segment 114 has an upper edge that defines the top edge 116 of the main door 102 when the main door 102 is in the closed position. Starting from the first segment to the last segment, each segment 114 is pivotally hinged to the adjacent succeeding segment 114, by one or more horizontal main door hinges 118, such that each segment 114 and its adjacent succeeding segment 114 are capable of pivotal movement relative to each other about a horizontal hinge axis. Two or more of the segments 114 have an open portion 120, 122 that cooperatively define the opening 104 in the main door 102 for the passage of individual persons.

In the illustrated example, the secondary door 100 has two or more panels 110 that are each pivotally hinged to any adjacent such panels 110, by one or more horizontal secondary door hinges 124, such that each panel 110 and any of its adjacent panels 110 are capable of pivotal movement relative to each other about a horizontal hinge axis. In the illustrated example, a plurality of hinges 112 connects the secondary door 100 to the main door 102. In the illustrated example, at least one vertical hinge 112 is provided for each panel 110 of the secondary door 100 for pivotally connecting that panel to the corresponding segment 114 of the main door 102. However, depending upon the height of the panel 110, more than one hinge 112 may be provided for each panel 110. The plurality of hinges 112 are provided along one side of the secondary door 100. The plurality of hinges 112 connecting the secondary door 100 to the main door 102 permit the secondary door 100 to move pivotally relative to the main door 102 about a vertical axis when the main door 102 is in the closed position. When the main door 102 is in the closed position, the hinge axes of all the hinges 112 are in alignment along a common vertical axis located in proximity to one side of the secondary door 100. In this configuration, the secondary door 100 can pivotally move relative to the main door 102, about the vertically aligned hinge axes of the hinges 112, between a closed position, blocking the opening 104, and an open position, permitting ingress and egress of individual persons through the opening 104.

Each pair of adjacent panels 110 of the secondary door 100 are pivotally movable relative to each other about a horizontal axis, which is the hinge axis of the hinge 124 that connects the pair of panels, that is coincident with a horizontal axis about which the corresponding pair of main door segments 114 are pivotally connected by corresponding hinges 118. Accordingly, when the secondary door 100 is in the closed position, the main door 102 can be lifted as usual by the door lifting mechanism (not shown) without interference by the secondary door 100 because the panels 110 can pivotally move relative to each other as the segments 114 pivot relative to one another while the main door 102 is being lifted. When the panels 110 pivotally move relative to each other, the hinge axes of all the hinges 112 are no longer in alignment along a common vertical axis and the panels 110 of the secondary door 100 cannot move out of the closed position, or toward an open position, relative to the corresponding segment 114 of the main door 102.

The secondary door 100 further comprises a latch 126 for holding the secondary door 100 in a closed position relative to the main door 102. The latch 126 can be of any suitable type. In the illustrative example, the latch 126 has a housing 128 that is attached to a panel 110 of the secondary door 100 proximate the edge of the secondary door that is farthest from the edge near which the hinges 112 are attached. In the illustrative example, the latch housing 128, and in turn the latch 126, is attached to the middle panel 110 of the secondary door 100; however, the latch may be attached to other panels 110 and multiple latches attached to multiple panels 110 may also be employed. The latch housing 128 supports a latch bolt 130 for rectilinear motion between closed and open positions. A knob or handle 132 can be used to move the latch bolt 130 between closed and open positions. A keeper 134 is attached to the corresponding segment 114 of the main door 102 that can receive a portion of the latch bolt 130 when the latch bolt 130 is in the closed position in order to maintain the secondary door 100 in the closed position. When the latch bolt 130 is moved to the retracted or open position, the latch bolt 130 is out of engagement with the keeper 134 and the secondary door 100 can be moved to the open position.

It should be understood that the present invention is not limited to the specific embodiments described above, but includes any and all variations or modifications within the spirit and scope of the present invention as defined in the appended claims.

1. A main door adapted for selectively allowing passage of vehicles into a building structure, said main door being formed in part by a secondary door dimensioned and configured for allowing ingress and egress of persons through said secondary door without the need for opening said main door in its entirety, wherein said secondary door is smaller than said main door.

2. A secondary door for providing a selectively openable closure for an opening dimensioned for the passage of persons in a main door that is dimensioned to provide a selectively openable closure for a passageway dimensioned for the passage of vehicles suitable for conveying at least one person into or out of a building structure, said secondary door comprising:
at least one secondary door panel; and
at least one hinge for attaching said secondary door panel to said main door, said secondary door panel being pivotally movable relative to the main door about a first hinge axis defined by said at least one hinge,
wherein the passageway has an area and the opening has an area and wherein the area of the passage way is larger than the area of the opening.

3. The secondary door according to claim 2, wherein the main door is an overhead door, wherein the main door has a width, a height, and a plurality of segments including a first segment and a last segment, each segment extending horizontally for the width of the main door, said first segment being adjacent the bottom of the passageway when the main door is in the closed position, said last segment having an upper edge that defines the top edge of the main door when the main door is in the closed position, wherein, starting from the first segment to the last segment, each segment is pivotally hinged to the adjacent succeeding segment such that each segment and its adjacent succeeding segment are capable of pivotal movement relative to each other about a horizontal hinge axis, wherein two or more of said segments have an open portion that cooperatively define the opening in the main door for passage of persons, wherein the secondary door has two or more panels that are each pivotally hinged to any adjacent such panels such that each panel and any of its adjacent panels are capable of pivotal movement relative to each other about a horizontal hinge axis, wherein said at least one hinge is one of a plurality of hinges connecting the secondary door to the main door, wherein said plurality of hinges connecting the secondary door to the main door permit the secondary door to move pivotally relative to the main door about a vertical axis when the main door is in the closed position, each pair of adjacent panels of the secondary door are pivotally movable relative to each other about a horizontal axis that is coincident with a horizontal axis about which a corresponding pair of main door segments are pivotally connected.

4. The secondary door according to claim 3, further comprising a latch for holding the secondary door in a closed position relative to the main door.

5. A secondary door for providing a selectively openable closure for an opening dimensioned for the passage of persons in a main door that is dimensioned to provide a selectively openable closure for a passageway dimensioned for the passage of vehicles suitable for conveying at least one person into or out of a building structure, said secondary door comprising:
at least one secondary door including a plurality of panels, each of said panels being connected to a neighboring panel by a hinge such that said secondary door includes a plurality of hinges,
wherein said secondary door panel is movable relative to the main door between a closed position and an open position,
wherein the passageway has an area and the opening has an area and wherein the area of the passage way is larger than the area of the opening,
wherein the main door is an overhead door, wherein the main door has a width, a height, and a plurality of segments including a first segment and a last segment, each segment extending horizontally for the width of the main door, said first segment being adjacent the bottom of the passageway when the main door is in the closed position, said last segment having an upper edge that defines the top edge of the main door when the main door is in the closed position, wherein, starting from the first segment to the last segment, each segment is pivotally hinged to the adjacent succeeding segment such that each segment and its adjacent succeeding segment are capable of pivotal movement relative to each other about a horizontal hinge axis, wherein two or more of said segments have an open portion that cooperatively define the opening in the main door for passage of persons, wherein the secondary door has two or more panels that are each pivotally hinged to any adjacent such panels such that each panel and any of its adjacent panels are capable of pivotal movement relative to each other about a horizontal hinge axis, wherein each pair of adjacent panels of the secondary door are pivotally movable relative to each other about a horizontal axis, and wherein there exists one of said plurality of hinges of said secondary door that has a horizontal hinge axis that is coincident with each horizontal axis about which a pair of main door segments are pivotally connected.

6. The secondary door according to claim 5, further comprising at least one latch for holding the secondary door in a closed position relative to the main door.
